(19) United States
(12) Patent Application Publication
(10) Pub. No.: US 2018/0310590 A1
(43) Pub. Date: Nov. 1, 2018

(54) HIGH-PROTEIN OILCAKE-BASED NUTRITIONAL COMPOSITION

(71) Applicant: Usarium Inc., Palo Alto, CA (US)

(72) Inventors: Aleh Manchuliantsau, Vitebsk (BY); Anastasia Tkacheva, Zelenograd (RU)

(21) Appl. No.: 15/965,992

(22) Filed: Apr. 30, 2018

Related U.S. Application Data
(60) Provisional application No. 62/492,367, filed on May 1, 2017.

(51) Int. Cl. A23J 1/14; A23P 30/20

(52) U.S. Cl. CPC A23J 1/14; A23P 30/20; A23L 29/212; A23V 2200/30; A23V 2300/16; A23V 2002/00

(57) ABSTRACT

This disclosure is concerned with a nutritional product, nutritional composition, and methods for manufacturing thereof. The nutritional product and composition are protein rich substances which include oilcake produced by a process involving steam explosion of raw oilcake such that dry matter left after oil extraction from sunflower seeds or other oily crops or nuts. According to one aspect of this disclosure, there is provided a nutritional product which is suitable for human consumption and comprises a high-protein main ingredient and a supplemental ingredient. The high-protein main ingredient includes sterile and palatable matter such as processed oilcake produced by steam explosion of substantially water-insoluble matter. The optional supplemental ingredient includes one or more of the following: carbohydrates, proteins, and fats.

### CROSS-REFERENCE TO RELATED APPLICATIONS

This application claims the benefit of U.S. provisional patent application Ser. No. 62/492,367 filed May 1, 2017 entitled “High-Protein Oilcake-Based Nutritional Composition,” which is incorporated herein by reference in its entirety for all purposes.

### BACKGROUND

### Technical Field

This disclosure generally relates to plant-based protein-rich nutritional products. More particularly, this disclosure relates to a high-protein oilcake-based nutritional composition and products thereof.

### Description of Related Art

Animal-based proteins have traditionally been considered as important sources of proteins and other nutrients for human consumption. Beef and dairy cattle milk are well known examples of animal-based protein sources; however, their production remains ineffective and costly. For example, according to recent research studies, 83-97% of initial nutrients fed to animals are lost and not available for human consumption. See Shepon et al., Energy and protein feed-to-food conversion efficiencies in the US and potential food security gains from dietary changes, Environ. Res. Lett. 11 (2016). These circumstances drive prices of animal-based proteins. In addition, the beef production is not efficient because cattle diets include plant-based feeds having about 35% of protein, while beef, as a final product, contains about 26% of protein. As the demand in protein sources continues to increase with the growing population, new sources of protein-rich foods and food ingredients are desirable.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

This disclosure is concerned with a nutritional product, nutritional composition, and methods for manufacturing thereof. The nutritional product and composition includes a high-protein main ingredient which includes oilcake produced by a process involving steam explosion of raw oilcake. For example, dry matter left after oil extraction from sunflower seeds can be used as the raw oilcake to create the high-protein main ingredient when subjected the steam explosion process.

The nutritional product and composition of this disclosure is a nutritionally dense product suitable for human consumption. For example, the product can be in the form of chips, flour, powder mix, pasta, nutritional bar, spread, dip, sauce, beverage, and so forth. As an example, chips made by the technology disclosed herein have about three times more protein, at least two times more fiber, and at least three times less fat per serving than typical comparable product available on the market such as potato chips. In addition, the nutritional product and composition of this disclosure are sterile, free of allergens, and unwanted microorganisms. Importantly, the nutritional product and composition of this disclosure do not include animal-based products, including, without limitation, whey, dairy, meat, eggs, fish, etc. Yet, the nutritional product and composition are filling, rich in necessary vitamins and minerals, an excellent source of protein suitable for most diets, improves microbiome, and decreases risk of obesity in the growing population. In addition, the disclosed nutritional product and composition are allergen-free, gluten-free, vegan, all-natural, and include no genetically modified organisms.

According to one aspect of this disclosure, there is provided a nutritional product suitable for human consumption. An example nutritional product comprises a high-protein main ingredient and an optional supplemental ingredient. The high-protein main ingredient includes a processed oilcake produced by a process involving steam explosion of raw oilcake which is substantially water-insoluble matter. High temperatures and pressure of the steam explosion make the processed oilcake sterile and palatable, and edible for humans. The optional supplemental ingredient includes one or more of the following: carbohydrates, proteins, and fats.

According to embodiments of this disclosure, the processed oilcake is based on one or more oily crops. For example, the processed oilcake can be produced from at least one of the following: sunflower oilcake, soybean oilcake, cotton seed oilcake, rapeseed oilcake, canola oilcake, copra oilcake, palm kernel oilcake, peanut oilcake, and olive oilcake. The term “oilcake” is the same as “oil cake,” “press cake,” “meal,” and “protein meal,” and these terms are interchangeable.

In some embodiments of this disclosure, the nutritional product is a complete substance which is ready for human consumption and it is not being used as part of another edible or drinkable substance. In other embodiments, the nutritional product is a complete substance ready for human consumption but can be used as an ingredient in another edible or drinkable product, such as chips, nutritional bars, protein bars, flour, powder mix, and the like.

According to another aspect of this disclosure, there is provided a nutritional composition (substance) suitable for human consumption. An example composition comprises from about 25% to about 99.9% of a high-protein main ingredient and from about 0.1% to about 75% of at least one supplemental ingredient. The high-protein main ingredient includes a processed oilcake produced by a process involving steam explosion of raw oilcake. The processed oilcake may represent at least 95% of the high-protein main ingredient by weight. The supplemental ingredient includes one or more of the following: carbohydrates, proteins, and fats.

According to embodiments of this disclosure, the processed oilcake is based on one or more oily crops. For example, the processed oilcake is produced from at least one of the following: sunflower oilcake, soybean oilcake, cotton seed oilcake, rapeseed oilcake, canola oilcake, copra oilcake, palm kernel oilcake, peanut oilcake, and olive oilcake. Moreover, in some embodiments, the supplemental ingredient can include potato starch or starch derived from one or more of the following: grains, tubers, tapioca, and cassava. In other embodiments, the supplemental ingredient includes flour derived from one or more of the following: rice, corn, wheat, rye, garbanzo, black beans, and pinto beans. Importantly, a ratio between the high-protein main ingredient and the supplemental ingredient can vary. For example, the ratio can be about 25% of the high-protein main ingredient to about 75% of the supplemental ingredient. In another example, the ratio is about 50% of the high-protein main ingredient to about 50% of the supplemental ingredient. In yet another example, the ratio is about 75% of the high-protein main ingredient to about 25% of the supplemental ingredient. Other ratios are also within the scope of this disclosure.

According to various embodiments of this disclosure, the process for producing the high-protein main ingredient includes receiving a plant-based material, which includes raw oilcake, and subjecting the plant-based material to the steam explosion to cause breaking apart large nutritional units of the plant-based material into smaller nutritional units of the plant-based material so as to transform the plant-based material into the high-protein main ingredient. The process may further comprise moistening the plant-based material prior to subjecting the plant-based material to the steam explosion. Notably, the steam explosion can be provided by extruding, but it is not limited to extruding. In some embodiments, the steam explosion is provided by one or more of the following: frying, heating, microwaving, puffing, and popping.

In the process, the plant-based material can include a mixture of the raw oilcake and the supplemental ingredient. In some embodiments, the high-protein main ingredient and the supplemental ingredient can be collectively processed into flour, flour-like product, chips, chips-like product, hummus-like product, or a drinkable product.

In some embodiments, the process further includes a post-processing operation performed after the steam explosion. The post-processing operation can include one or more of the following: grinding, cutting, milling, hot oil or hot air expanding, popping, puffing, drying, and coating.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 illustrates an example system for producing the nutritional product (composition) according to one example embodiment; and

FIG. 2 is a block diagram showing a method for producing a nutritional product (composition) according to an example embodiment.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.” The term “about” shall be construed to mean less or equal to a 20% deviation from a recited value.

The term “oilcake” should mean a matter remaining after pressing something to extract the liquids. For example, oilcake is a substance or mass of compressed seed or other plant material left after its oil has been extracted. The terms “oilcake,” “oil cake,” “press cake,” and “meal” are interchangeable and should mean the same.

This disclosure concerns a nutritional composition and a nutritional product which are protein-rich edible products suitable for oral consumption by people. For simplicity, the terms “nutritional composition” and “nutritional product” can be used interchangeably in this document and, unless otherwise specified, these terms shall be construed to mean one or more of the following: a nutritional powder, nutritional flour, nutritional semi-solids (e.g., nutritional chips or “snacks”), nutritional semi-liquids (e.g., spreads, dips, hummus-like, or yogurt-like products), nutritional liquids, and nutritional shakes. One or more of the above-listed forms of the nutritional product can be reconstructed from one form to another. Furthermore, in view of the different forms of the nutritional product, it can be a ready-to-consume and complete product or serve as an ingredient to produce other products.

The main ingredient of the nutritional product (composition) is processed oilcake. The processing is substantially based on a steam explosion process as described below. Some examples of the steam explosion include extruding, frying, air popping, heating, and microwaving. The processed oilcake can be produced from a wide group of various raw oilcakes, including, for example, sunflower oilcake, soybean oilcake, cotton seed oilcake, rapeseed oilcake, canola oilcake, peanut oilcake, palm kernel meal, copra meal, or a mixture thereof.

In some embodiments, one or more supplemental ingredients can be added to the main ingredient. For example, the supplemental ingredients can include certain carbohydrates, proteins, or fats. In one example, the carbohydrates include starches. Proteins can include any suitable plant-based or animal-based proteins. Fats can include oils. A ratio between the main ingredient and the supplemental ingredient can be in the following ranges: from about 25% to about 99.9% of the main ingredient and from about 0.1% to about 75% of the supplemental ingredient. These ratios were proven to effectively provide protein-rich nutritional products, which, unexpectedly, are easily digested by most population groups and do not lead to obesity issues.

The methods for producing the nutritional products of this disclosure was also unexpectedly found inexpensive and efficient. These methods ensure that the nutritional product is of a high quality and free from allergens, gluten, toxins, and fungus. The present methods allow for producing the protein-based products more than ten times less expensive than a traditional way of exploiting animals, such as cows, to produce conventional animal-based protein sources. Moreover, studies suggested that the nutritional product produced by the methods disclosed herein provide about 40% less risk of heart disease. Last, but not least, the present methods are more sustainable for the planet environment as they require a significantly reduced use of land and reduced gas emissions comparing to the traditional animal-based protein production methods.

According to various embodiments of this disclosure, one method for producing the nutritional product includes the following operations. At a first operation, a raw plant-based material is received at a system as an input material. The raw plant-based material may include raw oilcake. Some examples of oilcakes include, but not limited to, sunflower oilcake, soybean oilcake, rapeseed oilcake, canola oilcake, copra meal, palm kernel oilcake, and peanut oilcake. Alternatively, wastes can be used as the raw plant-based material. Examples of the wastes include, for example, raw wood, processed wood, paper, sludge left from paper manufacturing, cellulose-based products, agricultural residues, forestry wastes, and the like. The above-listed wastes contain carbohydrate polymers such as cellulose. As such, these wastes are not water-soluble and may not be consumable by people.

As the raw plant-based material may be dry (e.g., it may contain less than 10% of water by weight), a second operation may include moistening of the raw plant-based material to produce a moistened plant-based material. The moistening operation is optional. The moistening may involve adding water or other liquids (e.g., purified water, spring water, milk, juice, nutritionally rich liquids, etc.). The moistening can be performed until the moistened plant-based material contains about 25-32% by weight of water. In addition, the moistening can be performed automatically by a pre-processing device of the system such as a mixer and an input conveyor. In yet other embodiments, the moistening can be combined with a third operation or performed in an extruder. In some embodiments, there can be employed one or more sensors to measure a moisture level of the raw plant-based material before and after moistening to ensure automatic moistening to a predetermined degree. The sensors can be coupled to a computing device, which can monitor and control the moistening.

At the third operation, the moistened plant-based material or the moistened plant-based material is supplied to a steam explosion device that provides a continuing steam explosion of the plant-based material as it is supplied to the device. One example of the steam explosion device is an extruder of the system. Other device examples include, without limitation, frying devices, heating guns, heaters, hot air fans, microwave ovens, puffing devices, popping devices, and the like.

The steam explosion device operates to transform the (moistened) plant-based material by breaking apart large nutritional units into small nutritional units. As a result of the steam explosion process, the plant-based material transforms and becomes porous, sterile, and palatable. The steam explosion device makes the protein inside the processed plant-based material palatable and available for human consumption. In other words, when the steam explosion device receives raw oilcake or moistened raw oilcake, it produces processed oilcake, which is used as the main or the only ingredient of the nutritional product of this disclosure.

In addition, as the steam explosion process involves high-pressure and high-temperature treatment, the high-protein main ingredient (i.e., oilcake) outputted from the steam explosion device is free from bacteria, infectious bacillus, and fungi. Toxic materials are decomposed during the steam explosion process and become inactive and non-dangerous for consumption by people. Furthermore, the proteins contained in the moistened plant-based material become denatured, thus making the high-protein main ingredient ready-to-consume.

When an extruder is used as the steam explosion device, the extruder can include a housing and one or more mixing screws contained therein. The mixing screws feed the moistened plant-based material through a small opening, where a mechanical force creates a high temperature and pressure. The high temperature and pressure at the opening causes steam explosion of the moistened plant-based material causing a break up of large or long molecular chains. This process sterilizes and makes ingredients palatable, and thus protein available for human consumption at the output of the extruder. The operation of extruder can be monitored by a computing device, which can monitor and control a rotational speed, a temperature inside the extruder, and other parameters based on sensor measurements, operation protocol, or operator's inputs.

Going back to the method for producing the nutritional product, at its fourth operation, optional post-processing of the high-protein main ingredient at the output of the steam explosion device can be performed. The post-processing may include, for example, grinding, cutting, milling, hot oil or hot air expansion, popping, puffing, drying, or coating. In addition, the post-processing may include packaging or bottling. In one example embodiment, the high-protein main ingredient from the steam explosion device (e.g., the extruder as discussed above) can be milled into flour and used as a food ingredient. Excessive moisture may be removed by additional heating or by using a drying device. In other embodiments, the high-protein main ingredient can be consumed as is.

Notice that the high-protein main ingredient at the output of the steam explosion device is allergen-free and rich in protein and fiber. For example, flour produced by the above method from sunflower oilcakes can contain about 35% of protein, about 45-50% of carbohydrates, about 15-20% of fiber, about 0% of sugars, and about 0-1% of fats. This is an unexpected result.

At a fifth operation, the high-protein main ingredient at the output of the steam explosion device or after the post-processing operation can be further mixed with one or more supplemental ingredients. In some embodiments, however, one or more of the supplemental ingredients are added at the extruder, rather than after extruding. The supplemental ingredients can include carbohydrates, proteins, or fats. As discussed above, the carbohydrates can include starches derived from one or more of the following: potatoes, grains, tubers, tapioca, and cassava. The supplemental ingredient can also include flour derived from one or more of the following: rice, corn, wheat, rye, garbanzo, black beans, and pinto beans. In addition, the supplemental ingredients can include minerals or vitamins including, for example, vitamin A, vitamin C, vitamin D, vitamin E, vitamin K, thiamine, riboflavin, pyridoxine, vitamin B12, carotenoids, niacin, folic acid, pantothenic acid, biotin, choline, inositol, salts, and derivatives thereof, or any combinations thereof. Further, the supplemental ingredients can include food agents, such as flavoring agents, preservatives, stabilizers, colorants, and the like.

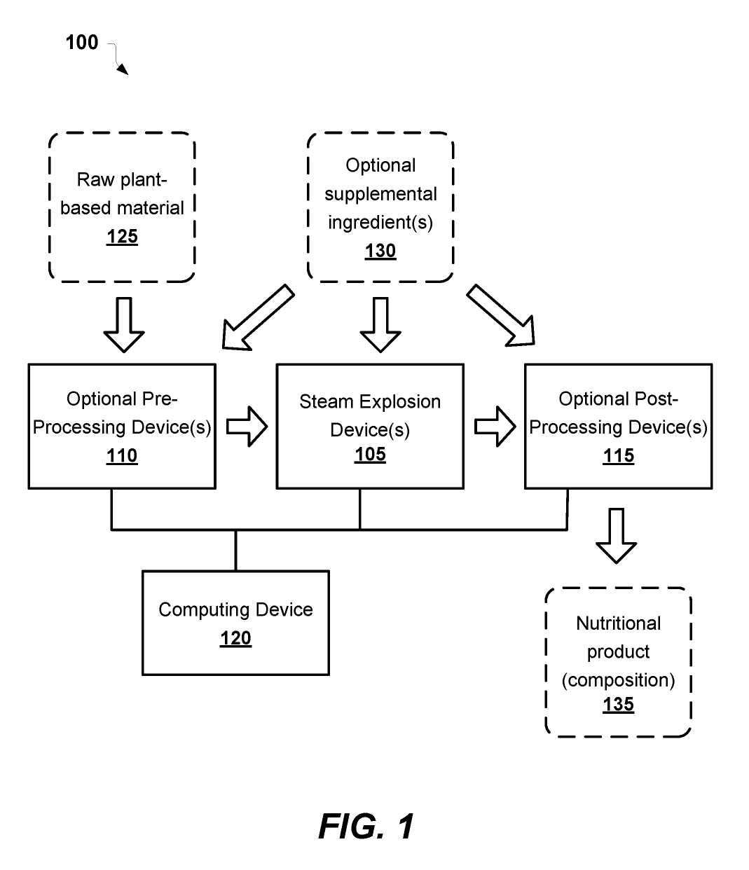

FIG. 1 illustrates an example system 100 for producing the nutritional product (composition) according to one example embodiment. As shown in the figure, system 100 includes a steam explosion device 105 which may include an extruder, heating device, microwaving device, frying device, and the like. This disclosure is focused on the use of an extruder solely as an example and not a limitation. Steam explosion device 105 receives raw plant-based material 125 (e.g., one or more oilcakes as discussed herein) or pre-processed raw plant-based material. Notably, raw plant-based material 125 can also include one or more optional supplemental ingredients 130. In some embodiments, there can be provided two or more steam explosion devices 105 connected in series. Steam explosion device 105 outputs a processed raw plant-based material (including any optional supplemental ingredients), which is also referred to as a high-protein main ingredient or nutritional composition 135.

An input of steam explosion device 105 may be operatively and directly connected to one or more optional pre-processing devices 110. Pre-processing devices 110 can include, without limitation, one or more mixers, grinders, cutting devices, dispensing devices, moisturizing devices, supplying devices, transporting devices, dosing devices, and so forth. It should be understood that one or more pre-processing devices 110 perform one or more pre-processing operations such as moistening by mixing raw plant-based material 130 with water or other liquids. It can also provide mixing raw plant-based material 130 with optional supplemental ingredients 130. One or more pre-processing devices 110 can also perform heating, cooling, compressing, decompressing, feeding, pressing, supplying, or any other similar operation against raw plant-based material 125 including one or more optional supplemental ingredients 130.

An output of steam explosion device 105 may be operatively and directly connected to one or more optional post-processing devices 115. Post-processing devices 115 receive the high-protein main ingredient from steam explosion device 105 and perform one or more optional post-processing operations. Example post-processing operations include, without limitation, one or more of the following: mixing, grinding, cutting, milling, hot oil or hot air expanding, popping, puffing, drying, and coating. As shown in the FIG. 1, one or more optional supplemental ingredients 130 can be introduced (and mixed) at any production stage, i.e., at pre-processing device 110, steam explosion device 105, or post-processing device 115. An output of post-processing devices 115 is a nutritional product (composition) 135.

As already discussed, system 100 can further include additional components, such as a computing device 120 and one or more sensors for controlling the operation of any or all devices used in system 100. Computing device 120 is configured to run software or a protocol to enable operation of system 100 at preferred parameters so as to make sure that the generation of nutritional product (composition) 135 is within predetermined or preferred regime. For example, sensors can measure a temperature and a conveying speed of extruder 105, while computing device 120 can adjust operation of any of pre-processing devices 110, extruder 105, or post-processing devices 115 to make sure that nutritional product (composition) 135 is of predetermined quality or has predetermined parameters (e.g., that it became sterile and palatable).

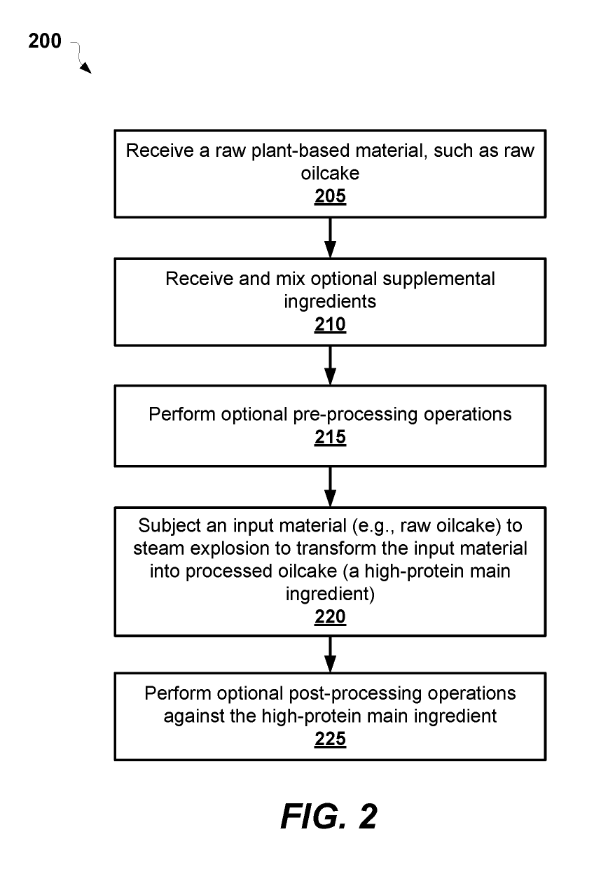

FIG. 2 is a block diagram showing a method 200 for producing a nutritional product (composition) according to an example embodiment. Method 200 may be performed by processing logic that may comprise hardware, software, or a combination of both. In one example embodiment, the processing logic refers to system 100 or its components. Below recited operations of method 200 may be implemented in an order different than described and shown in the figure. Moreover, method 200 may have additional operations not shown herein, but which can be evident for those skilled in the art from the present disclosure. Method 200 may also have fewer operations than outlined below and shown in FIG. 2.

Method 200 commences at step 205 with system 100 receiving a raw plant-based material, such as raw oilcake. The raw oilcake is substantially water-insoluble, not sterile, and not palatable. The raw oilcake can be based on one or more oily crops. For example, the raw oilcake can include sunflower oilcake, soybean oilcake, cotton seed oilcake, rapeseed oilcake, canola oilcake, copra oilcake, palm kernel oilcake, peanut oilcake, and olive oilcake.

At step 210, system 100 receives and mixes one or more optional supplemental ingredients. The supplemental ingredients can include one or more of the following: carbohydrates, proteins, and fats. For example, the supplemental ingredients can include potato starch or starch derived from one or more of the following: grains, tubers, tapioca, and cassava. The supplemental ingredients can also include flour derived from one or more of the following: rice, corn, wheat, rye, garbanzo, black beans, and pinto beans. The supplemental ingredients can include vitamins, minerals, and food agents, such as flavoring agents, preservatives, stabilizers, colorants, and the like. At step 210, one or more optional supplemental ingredients can be mixed with the raw plant-based material. In certain embodiments, one or more optional supplemental ingredients are provided and mixed at step 225 discussed below.

At step 215, system 100 performs one or more optional pre-processing operations against the raw plant-based material or the mix of the raw plant-based material with one or more supplemental ingredients (collectively referred to as “input material” for simplicity). The pre-processing operations can include mixing the input material with water or other liquids. The pre-processing operations can also include heating, pressing, grinding, cutting, conveying, and the like.

At step 220, system 100 subjects the input material (i.e., the plant-based material, the mix of the raw plant-based material with one or more supplemental ingredients, or an output obtained from pre-processing step 215) to steam explosion to cause a break up of large nutritional units of the plant-based material into small nutritional units of the plant-based material so as to transform the input material into a processed oilcake of a high-protein main ingredient. The processed oilcake may represent at least 95% of the high-protein main ingredient by weight. Notably, the high-protein main ingredient is obtained at step 220 not by isolation from the input material, but rather by transforming the input material into the processed oilcake by the steam explosion process such as by extrusion at a high temperature and high pressure. The steam explosion can be also provided by frying, heating, microwaving, puffing, or popping.

In case of extruding, a 42-inch Twin Screw extruder can be used at step 220. Its example operating parameters can include: (a) dry feed rate is about 200 kg/h; (b) a water rate is about 14% of the dry feed rate; (c) a screw speed is at least 500 rpm; and (d) a barrel temperature profile is as follows: Barrel 1 is at room temperature or cooled, while Barrels 2, 3, and 4 are kept at the temperature of more than 100° C.

At step 225, system 100 performs one or more optional post-processing operations against the processed oilcake (high-protein main ingredient). The post-processing operations can include one or more of the following: grinding, cutting, milling, hot oil or hot air expanding, popping, puffing, drying, and coating. In addition, the post-processing operations can include adding or mixing one or more optional supplemental ingredients. Further, the post-processing operations can include dispensing, packaging, bottling, cooking, and the like. As a result of post-processing, the high-protein main ingredient and the supplemental ingredients are collectively processed into flour, flour-like, chips, chips-like product, or a drinkable product. Thus, the output of method 200 can be a complete substance (product) which is ready for human consumption. It can be used as a component in another edible substance or product, but it is not necessary.

Notably, various parameters of method 200 can be constantly monitored by a computing device and adjusted to make sure that a ratio between the high-protein main ingredient and at least one supplemental ingredient is within a predetermined range. As such, the nutritional product (composition) produced by method 200 is suitable for human consumption and includes from about 25% to about 99.9% of the high-protein main ingredient and from about 0.1% to about 75% of at least one supplemental ingredient. Some example ratios are as follows: (1) about 25% of the high-protein main ingredient and about 75% of at least one supplemental ingredient; (2) about 50% of the high-protein main ingredient and about 50% of at least one supplemental ingredient; (3) about 75% of the high-protein main ingredient and about 25% of at least one supplemental ingredient; (4) about 99% of the high-protein main ingredient and about 1% of at least one supplemental ingredient; (5) about 95% of the high-protein main ingredient and about 5% of at least one supplemental ingredient; (6) about 90% of the high-protein main ingredient and about 10% of at least one supplemental ingredient; (7) about 80% of the high-protein main ingredient and about 20% of at least one supplemental ingredient; (8) about 70% of the high-protein main ingredient and about 30% of at least one supplemental ingredient; (9) about 60% of the high-protein main ingredient and about 40% of at least one supplemental ingredient; and so forth. At least some of the above ratios were unexpectedly found to provide protein-rich nutritional products in effective and inexpensive manner, and where the protein-rich nutritional products are easily digested by most human population groups.

Thus, method 200 can be used to produce one or more nutritional products (compositions). Example input ingredients, including raw oilcake and supplemental ingredient, in method 200 can include, without limitation, the following:
Example 1: raw oilcake includes about 69.65% of sunflower cake and supplemental ingredients include about 29.85% of potato starch and about 0.5% of potassium salt;
Example 2: raw oilcake includes about 70% of sunflower oil cake % and supplemental ingredients include about 20% of sorghum flour and about 10% of potato starch;
Example 3: raw oilcake includes about 60% of sunflower oil cake and supplemental ingredients include about 25% of oatmeal flour, about 14.5% of potato starch, and about 0.5% of baking powder; and
Example 4: raw oilcake includes about 52% of sunflower oil cake and supplemental ingredients include about 25% of rice flour, about 22.5% of potato starch, and about 0.5% of baking powder.

The final nutritional product profile obtained for the examples 1 through 4 includes: (a) bulk density at about 190-200 g/100 in³, and (b) moisture content at about 2-4%.

As discussed above, the steam explosion process transforms the input material (e.g., raw oilcake or a mix of raw oilcake and one or more supplemental ingredients), which is not sterile and not palatable, into the high-protein material (e.g., the processed oilcake), which is substantially sterile and palatable. The following two examples illustrate the sterilization upon applying method 200.

Example No. 1: As an input material (raw oilcake), sunflower oilcake collected on Jun. 27, 2017 was supplied to an extruder (e.g., the 42-inch Twin Screw extruder discussed above). An aerobic plate count of input material was about 49,000 CFU/g, a coliform bacteria level was about 460 CFU/g, an E. coli (non-pathogenic) level was less than 10 CFU/g, a mold level was about 7,000 CFU/g, a yeast level was at about 80 CFU/g, and tests on listeria species and salmonella were negative. As an output from the extruder, the processed oilcake was obtained from the input material on Jul. 5, 2017. The aerobic plate count of processed oilcake was less than 10 CFU/g, the coliform bacteria level was less than 10 CFU/g, the E. coli (non-pathogenic) level was less than 10 CFU/g, the mold level was less than 10 CFU/g, the yeast level was less than 10 CFU/g, and tests on listeria species, salmonella, and aflatoxin were negative.

Example No. 2: As an input material (raw oilcake), sunflower oilcake collected on Jun. 17, 2017 was supplied to an extruder (e.g., the 42-inch Twin Screw extruder discussed above). The aerobic plate count of the input material was about 75,000 CFU/g, the coliform bacteria level was at about 370 CFU/g, the E. coli (non-pathogenic) level was less than 10 CFU/g, the mold level was at about 17,000 CFU/g, the yeast level was at about 16,000 CFU/g, and tests on listeria species and salmonella were negative. As an output from the extruder, the processed oilcake in the form of chips was obtained from the input material on Dec. 12, 2017. The aerobic plate count of processed oilcake was less than 10 CFU/g, the coliform bacteria level was less than 10 CFU/g, the E. coli (non-pathogenic) level was less than 10 CFU/g, the mold level was less than 10 CFU/g, the yeast level was less than 10 CFU/g, and tests on listeria species, salmonella, and aflatoxin were negative.

Thus, the high-protein oilcake-based nutritional products (compositions) and methods for producing thereof have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A nutritional product suitable for human consumption, the nutritional product comprising:
a high-protein main ingredient, wherein the high-protein main ingredient includes processed oilcake, wherein the processed oilcake is produced by a process involving steam explosion of water-insoluble raw oilcake; and
an optional supplemental ingredient, wherein the optional supplemental ingredient includes one or more of the following: carbohydrates, proteins, and fats.

2. The nutritional product of claim 1, wherein the processed oilcake is substantially sterile and palatable.

3. The nutritional product of claim 1, wherein the processed oilcake is based on one or more oily crops.

4. The nutritional product of claim 1, wherein the processed oilcake is produced from sunflower oilcake.

5. The nutritional product of claim 1, wherein the processed oilcake is produced from soybean oilcake.

6. The nutritional product of claim 1, wherein the processed oilcake is produced from cotton seed oilcake.

7. The nutritional product of claim 1, wherein the processed oilcake is produced from rapeseed oilcake or canola oilcake.

8. The nutritional product of claim 1, wherein the processed oilcake is produced from copra oilcake.

9. The nutritional product of claim 1, wherein the processed oilcake is produced from palm kernel oilcake.

10. The nutritional product of claim 1, wherein the processed oilcake is produced from peanut oilcake.

11. The nutritional product of claim 1, wherein the processed oilcake is produced from olive oilcake.

12. The nutritional product of claim 1, wherein the nutritional product is a complete substance and is ready for human consumption and wherein the nutritional product is not part of another edible substance.

13. A nutritional composition suitable for human consumption, the nutritional composition comprising:
from about 25% to about 99.9% of a high-protein main ingredient, wherein the high-protein main ingredient includes a processed oilcake produced by a process involving steam explosion of raw oilcake; and
from about 0.1% to about 75% of at least one supplemental ingredient, wherein the supplemental ingredient includes one or more of the following: carbohydrates, proteins, and fats.

14. The nutritional composition of claim 13, wherein the processed oilcake is sterile and palatable.

15. The nutritional composition of claim 13, wherein the processed oilcake is produced from one or more of the following: sunflower oilcake, cotton seed oilcake, rapeseed oilcake, canola oilcake, copra oilcake, palm kernel oilcake, peanut oilcake, and olive oilcake.

16. The nutritional composition of claim 13, wherein the processed oilcake is soy oilcake or soybean meal.

17. The nutritional composition of claim 13, wherein the supplemental ingredient includes tapioca starch.

18. The nutritional composition of claim 13, wherein the supplemental ingredient includes starch derived from one or more of the following: grains, tubers, potato, and cassava.

19. The nutritional composition of claim 13, wherein the supplemental ingredient includes flour derived from one or more of the following: rice, corn, wheat, rye, garbanzo, black beans, and pinto beans.

20. The nutritional composition of claim 13, wherein a ratio between the high-protein main ingredient and the supplemental ingredient is about 25% of the high-protein main ingredient to about 75% of the supplemental ingredient.

21. The nutritional composition of claim 13, wherein a ratio between the high-protein main ingredient and the supplemental ingredient is about 50% of the high-protein main ingredient to about 50% of the supplemental ingredient.

22. The nutritional composition of claim 13, wherein a ratio between the high-protein main ingredient and the supplemental ingredient is about 75% of the high-protein main ingredient to about 25% of the supplemental ingredient.

23. The nutritional composition of claim 13, wherein the process for producing the high-protein main ingredient includes:
receiving a plant-based material, wherein the plant-based material includes raw oilcake which is substantially water-insoluble; and
subjecting the plant-based material to the steam explosion to cause a break up of large nutritional units of the plant-based material into small nutritional units of the plant-based material to transform the plant-based material into the high-protein main ingredient which is substantially sterile and palatable.

24. The nutritional composition of claim 23, wherein the process further comprises:
moistening the plant-based material prior to subjecting the plant-based material to the steam explosion.

25. The nutritional composition of claim 23, wherein the steam explosion is provided by extruding.

26. The nutritional composition of claim 23, wherein the steam explosion is provided by one or more of the following: frying, heating, microwaving, puffing, and popping.

27. The nutritional composition of claim 23, wherein the plant-based material includes a mixture of the raw oilcake and the supplemental ingredient.

28. The nutritional composition of claim 27, wherein the high-protein main ingredient and the supplemental ingredient are collectively processed into a flour, flour-like product, chips, chips-like product, pasta, noodles, ramen, or pasta-like products.

29. The nutritional composition of claim 27, wherein the high-protein main ingredient and the supplemental ingredient are collectively processed to produce semi-liquid hummus-like dip, soup, or soup-like product or a drinkable product.

30. The nutritional composition of claim 23, wherein the process further includes a post-processing operation performed after the steam explosion, wherein the post-processing operation includes one or more of the following: grinding, cutting, milling, hot oil or hot air expanding, popping, puffing, drying, and coating.
